(19) United States
(12) Patent Application Publication
(10) Pub. No.: US 2010/0087308 A1
(43) Pub. Date: Apr. 8, 2010

(54) METHODS FOR CONVERSION OF METHANE TO USEFUL HYDROCARBONS, CATALYSTS FOR USE THEREIN, AND REGENERATION OF THE CATALYSTS

(75) Inventors: Joe D. Sauer, Baton Rouge, LA (US); Tyson J. Hall, Baton Rouge, LA (US); George Wyndham Cook, Baton Rouge, LA (US); Joseph E. Coury, Friendswood, TX (US)

Correspondence Address: ALBEMARLE CORPORATION;PATENT DEPARTMENT, 451 FLORIDA STREET, BATON ROUGE, LA, 70801, US

(73) Assignee: ALBEMARTE CORPORATION, BATON ROUGE, LA (US)

(21) Appl. No.: 12/442,223

(22) PCT Filed: Sep. 14, 2007
(86) PCT No.: PCT/US07/78488

§ 371 Date: Mar. 20, 2009

Related U.S. Application Data
(60) Provisional application No. 60/846,274, filed on Sep. 21, 2006.
(60) Provisional application No. 60/867,710, filed on Nov. 29, 2006.

(51) Int. Cl. B01J 38/00

(52) U.S. Cl. 502/20

(57) ABSTRACT

Methods are provided for regenerating catalyst compositions useful in processes for converting methane to useful hydrocarbons. The methods comprise applying voltage across the catalyst compositions.

### BACKGROUND

Methane is a major constituent of natural gas and also of biogas. World reserves of natural gas are constantly being upgraded. However, a significant portion of the world reserves of natural gas is in remote locations, where gas pipelines frequently cannot be economically justified. Natural gas is often co-produced with oil in remote offsite locations where reinjection of the gas is not feasible. Much of the natural gas produced along with oil at remote locations, as well as methane produced in petroleum refining and petrochemical processes, is flared. Since methane is classified as a greenhouse gas, future flaring of natural gas and methane may be prohibited or restricted. Thus, significant amounts of natural gas and methane are available to be utilized.

Different technologies have been described for utilizing these sources of natural gas and methane. For example, technologies are available for converting natural gas to liquids, which are more easily transported than gas. Various technologies are described for converting methane to higher hydrocarbons and aromatics.

The Fischer Tropsch reaction has been known for decades. It involves the synthesis of liquid (or gaseous) hydrocarbons or their oxygenated derivatives from the mixture of carbon monoxide and hydrogen (synthesis gas) obtained by passing steam over hot coal. This synthesis is carried out with metallic catalysts such as iron, cobalt, or nickel at high temperature and pressure. The overall efficiency of the Fischer Tropsch reaction and subsequent water gas shift chemistry is estimated at about 15%, and while it does provide a route for the liquefication of coal stocks, it is not adequate in its present level of understanding and production for conversion of methane-rich stocks to liquid fuels.

It is possible to hydrogenate carbon monoxide to generate methanol. Methanol, by strict definition of the “gas to liquid” descriptor, would seem to fulfill the target desire of liquefication of normally gaseous, toxic feedstocks. However, in many regards, the oxygen containing molecules have already relinquished a significant percentage of their chemical energy by the formation of the C—O bond present. A true “methane to liquid hydrocarbon” process would afford end products that would not suffer these losses.

Yet another approach for methane utilization involves the halogenation of the hydrocarbon molecule to halomethane and subsequent reactions of that intermediate in the production of a variety of materials. Again, the efficiency and overall cost performance of such routes would be commercially prohibitive. Such a halogenation process would also suffer from the decrease of stored chemical energy during the C—X bond formation. Additionally, the halogen species has to be satisfactorily accounted for (i.e., either recycled, or captured in some innocuous, safe form) within the end-use of the product from this overall route.

Gas to liquid processes that can convert methane into liquid fuels have been a significant challenge to the petrochemical industry at large. Of note are the works of Karl Ziegler and Giulio Natta regarding aluminum catalysts for ethylene chain growth, culminating in the 1963 Nobel Prize for Chemistry; the work of George Olah in carbocation technology, for which Mr. Olah received the 1994 Nobel Prize for Chemistry; and the work of Peter Wasserscheid regarding transition metal catalysis in ionic liquid media.

In spite of technologies that are currently described and available, a need exists for commercially feasible means for converting methane to useful hydrocarbons.

### THE INVENTION

This invention meets the above-described need by providing methods for regenerating catalyst compositions useful for converting methane to C₅ and higher hydrocarbons, which catalyst compositions are derived from (or prepared by combining) at least (i) AlHₙX¹ₘRₚ, where Al is aluminum, H is hydrogen, each X¹ is a halogen and can be the same as, or different from, any other X¹, each R is a C₁ to C₄ alkyl and can be the same as, or different from, any other R, each of n and m is independently 0, 1 or 2, and p is 1 or 2, all such that (n+m+p)=3, and (ii) M^{v}H_{q}X²ᵣ, where M^{v} is a metal of valence v, H is hydrogen, each X² is a halogen and can be the same as, or different from, any other X², and each of q and r is 0 or any integer through and including v, all such that (q+r)=v, and which methods comprise applying voltage across the catalyst compositions. The voltage applied can be from about 0.1 to about 5 volts. The voltage can be applied for about 6 seconds to about 10 minutes. Alternatively, or in conjunction with the electronic regeneration, i.e., application of voltage, the catalyst compositions can be regenerated by being subjected to elevated temperatures and/or chemical processing (e.g., treatment with base or oxidizer).

In catalysts regenerated according to the methods of this invention, the valence of M^{v}, (i.e., v) can be zero. Such catalyst compositions can be derived from (or prepared by combining) at least two or more of such AlHₙX¹ₘRₚ, where each AlHₙX¹ₘRₚ can be the same as, or different from, any other AlHₙX¹ₘRₚ and two or more of such M^{v}H_{q}X²ᵣ, where each M^{v}H_{q}X²ᵣ can be the same as, or different from, any other M^{v}H_{q}X²ᵣ. Additionally, catalyst compositions regenerated according to methods of this invention can be derived from (or prepared by combining) at least AlHₙXₘRₚ where either n or m is zero, and M^{v}H_{q}X²ᵣ, where M^{v} is a metal of valence v, H is hydrogen, each X² is a halogen and can be the same as, or different from, any other X², and each of q and r is 0 or any integer through and including v, all such that (q+r)=v. Catalyst compositions regenerated according to the methods of this invention are also useful for converting methane and C₂ to C₄ alkanes to C₅ and higher hydrocarbons. The following can be combined to form a reaction mixture: at least (i) a fluid comprising H₂ and methane, (ii) AlHₙX¹ₘRₚ, where Al is aluminum, H is hydrogen, each X¹ is a halogen and can be the same as, or different from, any other. X¹, each R is a C₁ to C₄ alkyl and can be the same as, or different from any other R, each of n and m is independently 0, 1, or 2, and p is 1 or 2, all such that (n+m+p)=3, and (iii) M^{v}H_{q}X²r, where M^{v} is a metal of valence v, His hydrogen, each X² is a halogen and can be the same as, or different from, any other X², and each of q and r is 0 or any integer through and including v, all such that (q+r)=v; and producing C₅ and higher hydrocarbons. Also, the following can be combined to form a reaction mixture: at least (i) a fluid comprising H₂ and methane and either (ii) two or more of such AlHₙX¹ₘRₚ, where each AlHₙX¹ₘRₚ can be the same as, or different from, any other AlHₙX¹ₘRₚ and/or two or more of such M^{v}H_{q}X²ᵣ, where each M^{v}H_{q}X²ᵣ can be the same as, or different from, any other M^{v}H_{q}X²ᵣ; or (ii) AlHₙX¹ₘRₚ where either of n or m is zero; and producing C₅ and higher hydrocarbons.

Catalyst composition can be regenerated according to this invention within the reaction mixture. For example, (i) fluid comprising H₂ and methane, (ii) AlHₙX¹ₘRₚ (as defined above), and (ii) M^{v}H_{q}X²ᵣ (as defined above) can be combined to form reaction mixture comprising catalyst composition and at any time during production of C₅ and higher hydrocarbons, voltage can be, applied across the reaction mixture to regenerate the catalyst composition in situ. Alternatively, catalyst composition can be separated from the reaction mixture and regenerated according to this invention. For example, (i) fluid comprising H₂ and methane (and, possibly, a plurality of C₂ to C₄ alkanes), (ii) AlHₙX¹ₘRₚ (as defined above), and (ii) M^{v}H_{q}X²ᵣ (as defined above) can be combined to form reaction mixture comprising catalyst composition and C₅ and higher hydrocarbons can be produced. The catalyst composition can be separated from the reaction mixture, e.g., by distilling off produced C₅ and higher hydrocarbons, leaving catalyst composition. Voltage can be applied across the thus separated catalyst composition to regenerate the catalyst composition.

As will be familiar to those skilled in the art, the terms “combined” and “combining” as used herein mean that the components that are “combined” or that one is “combining” are put into a container with each other.

Examples of AlHₙX¹ₘRₚ in catalysts regenerated according to methods of this invention include aluminum halides, aluminum alkyls, and related compounds, including aluminum hydrates. Examples of M^{v}H_{q}X²ᵣ in catalysts regenerated according to methods of this invention are transition metal halides, transition metal hydrides, and zero-valent metals.

### AlHₙX¹ₘRₚ

Suitable aluminum halides and related compounds AlHₙX¹ₘRₚ include, for example, aluminum methyl chloride (AlMeCl₂), aluminum methyl bromide (AlMeBr₂), mono-chloro aluminum methyl hydride (AlHMeCl) and mono-bromo aluminum methyl hydride (AlHMeBr). Other suitable compounds AlHₙX¹ₘRₚ are known or may come to be known, as will be familiar to those skilled in the art and having the benefit of the teachings of this specification.

### Transition Metal Halides and Related Compounds M^{v}H_{q}X²ᵣ

Suitable transition metal halides and related compounds M^{v}H_{q}X²ᵣ can be derived from components comprising transition metals such as titanium and vanadium and from components comprising halogen atoms such as chlorine, bromine, and iodine. For example, titanium bromide (TiBr₄) is a suitable transition metal halide. Suitable transition metal halides M^{v}H_{q}X²ᵣ include, for example, TiX²₃ (“titanium haloform”) where q is zero and each X² is a halogen atom (such as chlorine or bromine) and can be the same as, or different from, any other X². Other suitable transition metal halides and related compounds M^{v}H_{q}X²ᵣ are known or may come to be known, as will be familiar to those skilled in the art and having the benefit of the teachings of this specification.

### Transition Metal Hydrides and Related Compounds M^{v}H_{q}X²ᵣ

Suitable transition metal hydrides and related compounds M^{v}H_{q}X²ᵣ can be derived from components comprising transition metals such as titanium and vanadium and from components comprising hydrogen atoms. For example, titanium hydride (TiH₄) is a suitable transition metal hydride. Other suitable transition metal hydrides and related compounds M^{v}H_{q}X²ᵣ are known or may come to be known, as will be familiar to those skilled in the art and having the benefit of the teachings of this specification.

### Zero-Valent Metals

Suitable zero-valent metals include, for example, any metal with at least one electron in its outermost (non-S) shell or with at least one electron more than d⁵ or f⁷ levels. Suitable zero-valent metals include Ti⁰, Al⁰, and Zr⁰. Numerous suitable zero valent metals are known or may come to be known as will be familiar to those skilled in the art and having the benefit of the teachings of this specification.

The metal halide component can allow for the methane conversion to take place in a essentially liquid state at modest operating parameters (e.g., temperatures of about 200° C. and pressures at or below about 200 atmospheres).

Using methods and catalysts described herein, methane can be converted to useful hydrocarbons by polymerization of methane substantially without the normally required conversion to an oxidized species, such as carbon monoxide. Thus, methane can be converted to useful hydrocarbons via a substantially direct catalytic process.

Methane can be converted to a reactive species capable of combining with other methane (or heavier products obtained from earlier reaction of this species) molecules to give carbon-carbon bond formation in an efficient manner, without substantial conversion to carbon/coke/charcoal by-products. This activation also takes place in such fashion that oxidation of methane to carbon monoxide (such as seen in Fischer Tropsch and water gas shift reactions) is not required and does not occur in substantial amounts. The products resulting from the technology of this invention would be highly branched, highly methylated hydrocarbons such as those desired for high octane gasoline fuel stocks.

Without limiting this invention, the following compounds may be formed in situ when catalyst compositions and/or methods described herein are used: M^{v}H•2(AlX²₂), M^{v}H₂•2(AlHX²), M^{v}X²•2(AlX²₂), and M^{v}X²₂•2(AlX²₂);

also the following where M is M^{v} as defined herein and X can be either an X¹ or an X² as defined herein:

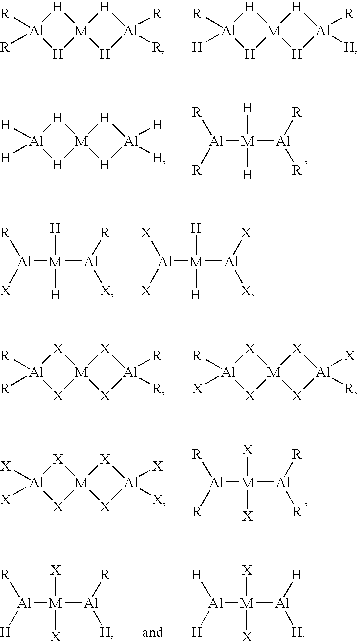

Methods described herein allow for the conversion of the under-utilized, and heretofore difficult to modify, hydrocarbon feed-stock methane in the generation of various higher hydrocarbons. The product hydrocarbons can be used as liquid fuels. This is not limiting, in that many of the higher hydrocarbons (chemical products) produced by methods described herein could have value in excess of that of gasoline or diesel liquid fuel stocks.

Use of catalysts and methods described herein could amount to substantial revenues in a refinery—where the technology could be applied—when using methane in place of the normal crude oil feedstocks. Additionally, if the technology can be adapted to small, remote, independent operations (such as found on drilling and production platforms remote from pipeline service) the profits would be amplified dramatically, since the natural gas in produced is such remote locations is typically flared.

Particular advantages of methods described herein for regenerating catalyst compositions are that application of voltage for regeneration is relatively easy to control and the energy requirement is relatively low, especially when compared to that of a typical Fischer Tropsch type operation.

Components referred to anywhere in the specification or claims hereof, whether by chemical name or formula or otherwise, and whether referred to in the singular or plural, are identified as they exist prior to coming into contact with another substance (e.g., another component, a solvent, etc.). It matters not what chemical changes, transformations and/or reactions, if any, take place in the resulting mixture or solution as such changes, transformations and/or reactions are the natural result of bringing the specified components together under the conditions specified. Thus the components are identified as ingredients to be brought together in performing a desired operation or in forming a desired composition. Also, even though the claims may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure.

While the present invention has been described in terms of one or more preferred embodiments, it is to be understood that other modifications may be made without departing from the scope of the invention, which is set forth in the claims below.

We claim:

1. A method for regenerating a catalyst composition that has been derived from at least (i) AlHₙX¹ₘRₚ, where Al is aluminum, H is hydrogen, each X¹ is a halogen and can be the same as, or different from, any other X¹, each R is a C₁ to C₄ alkyl and can be the same as, or different from, any other R, each of n and m is independently 0, 1, or 2, and p is 1 or 2, all such that (n+m+p)=3, and (ii) M^{v}H_{q}X²ᵣ, where M^{v} is a metal of valence v, H is hydrogen, each X² is a halogen and can be the same as, or different from, any other X², and each of q and r is 0 or any integer through and including v, all such that (q+r)=v, the method comprising applying voltage across the catalyst composition.

2. A method according to claim 1 wherein the voltage applied across the catalyst composition is about 0.1 volts to about 5 volts.

3. A method according to claim 1 wherein the voltage applied across the catalyst composition is applied from about 6 seconds to about 10 minutes.

4. A method according to claim 1 wherein the AlHₙX¹ₘRₚ comprises aluminum methyl bromide.

5. A method according to claim 1 wherein the M^{v}H_{q}X²ᵣ comprises titanium bromide.
